(19) United States
(12) Patent Application Publication
(10) Pub. No.: US 2006/0252854 A1
(43) Pub. Date: Nov. 9, 2006

(54) Multi-gate reaction injection assembly for use with a closed mold for mixing and setting iso and poly fluid based polymers withoneor more aggregate filler material

(76) Inventor: Miguel A. Linares, Bloomfield Hills, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/405,396

(22) Filed: Apr. 17, 2006

Related U.S. Application Data
(60) Provisional application No. 60/671,813, filed on Apr. 15, 2005.

(51) Int. Cl. B29C 47/10

(52) U.S. Cl. 523/348; 264/328.1; 425/130

(57) ABSTRACT

The present invention discloses a multi-gate assembly for creating a composite article, typically including a mold including a closed interior cavity, a first mixing gate in communication with the mold, and at least one iso-based polymer material and at least one poly-based polymer material concurrently fed into the first mixing gate. At least one filler material is fed into a second gate in communication with the first gate, and a composite associated with the iso/poly/filler materials is communicated into the cavity for formation into a three-dimensional article.

### CROSS REFERENCE TO RELATED APPLICATIONS

The present application claims the priority of U.S. Provisional Patent Application Ser. No. 60/671,813, filed Apr. 15, 2005, for Multi-Gate Reaction Injection Assembly for Use with a Closed Mold for Mixing and Setting ISO and Poly Fluid Based Polymers with One or More Aggregate Filler Material.

### BACKGROUND OF THE INVENTION

1. Field of the Invention

The present invention is directed to a plurality of variants for facilitating multi-gate reaction injection molding of both poly and iso based polymer and plastic materials, typically in a fluidic state. One or more volumes of an aggregate filler, either fluidic, powder or granulate based, are concurrently fed into a closed mold associated with the reaction injection molding operation, the filter material(s) being intermixed with the iso and poly based fluids and prior to injecting into a negative cavity impression of a desired part to be manufactured. The ability to intermix one or more filler materials, in a succeeding gate following the intermixing of the poly and iso fluid materials, greatly expands the possible combinations of material content associated with parts produced by the reaction injection molding process.

2. Description of the Prior Art

The prior art is well documented with examples of foamable and plasticized compositions constructed of one or more plasticized materials and including such as a composite or filler material. The objective is to create a three-dimensional and structural article exhibiting a given material consistency for a given application.

A first example drawn from the prior art is set forth in Maruyama et al., U.S. Pat. No. 6,322,344, and which teaches an injection molding apparatus for creating a multi-layered article. A mold includes a cavity provided with a cavity and a hot runner block. First and second injection cylinders are accessible to the mold cavity via associated resin flow passages for connecting an inside of the second injection cylinders and the cavity.

Czaplicki et al., U.S. Pat. No. 6,787,579, teaches a two-component (epoxy/amine) structural foam in place material, and by which the epoxy component is cross linked through a polymerization reaction catalyzed by the amine formulation. A reactive mixture or exothermic reaction is created between the epoxy component and the amine component when combined. The heat generated by the exothermic reaction softens a thermoplastic shell of a blowing agent formulated within the thermoplastic shell of the blowing agent to expand from the heat generated by the exothermic reaction.

U.S. Pat. No. 4,491,553, issued to Yamada et al., teaches a method for producing a filler loaded thermoplastic resin composite by mixing a thermoplastic resin and filler, and which is applied to a molding machines such as extrusion and injection molded machines, without the occurrence of segregation between the resin and filler. Perez, U.S. Pat. No. 6,323,251, teaches a thermoplastic/thermoset hybrid foam by which the thermoset forms a discontinuous phase in a continuous thermoplastic phase.

Muenz et al., U.S. Patent Application Publication No. 2004/0266899, teaches an expandable thermosettable composition containing at least one epoxy resin, at least one finely divided thermoplastic polymer powder, at least one blowing agent, at least one curing agent, and at least one filler suitable for the production of thermosetting laminated bodies with a tacky surface. The expandable thermosettable compositions are also suitable for the production of thermosetting, thermally expanded shaped articles for reinforcing hollow structural members by the injection molding process.

Finally, U.S. Pat. No. 4,474,900, issued to Dominguez, teaches reaction injection molded elastomers derived from high molecular weight amine terminated, polyethers and/or high molecular weight polyols, a chain extender, a polyisocyanate and an epoxy modified filler material. The reaction injection molded (RIM) elastomers of this invention are useful, for example, as automobile body parts.

### SUMMARY OF THE PRESENT INVENTION

The present invention discloses a multi-gate assembly for creating a composite article, typically including a mold including a closed interior cavity, a first mixing gate in communication with the mold, and at least one iso-based polymer material and at least one poly-based polymer material concurrently fed into the first mixing gate. At least one filler material is fed into a second gate in communication with the first gate, and a composite associated with the iso/poly/filler materials is communicated into the cavity for formation into a three-dimensional article.

Additional features include each of the iso and poly based materials having a fluidic composition and the filler material further including at least one of a fluidic, powderized or granulate/aggregate consistency. The filler material may further include a particulate material, exhibiting an individual diameter in a range of between ½ to 5 millimeters, and be constructed of either of an organic or inorganic based material.

Yet additional features include a first filler material reservoir and a second filler material reservoir, materials from each being fed into the second gate. The second gate is located in fluidly communicating fashion with an outlet location associated with the first gate.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first example, in cutaway, of a closed reaction injection mold assembly including a first iso/poly mixing gate, combined with a succeeding gate for intermixing one or more aggregate filler materials and prior to depositing within a negative cavity associated with the mold;

FIG. 2 is a further example of a closed mold assembly exhibiting a further configuration for intermixing iso/poly materials with a specified aggregate filler;

FIG. 3 is a further example of a closed mold and illustrating a still further configuration for intermixing iso, poly, and filler based materials;

FIG. 4 illustrates a yet further example of a closed mold arrangement and by which a filler material is intermixed at a second gate subsequent to a mixing stream gate associated with the poly and iso based materials;

FIG. 5 is an illustration of a mold assembly according to a yet further preferred embodiment and including volume holding reservoirs associated with the poly and iso based materials, in combination with first and second individual aggregate filler reservoirs, for supplying successive and communicating first and second mixing gates associated with a closed mold;

FIG. 6 is a variant illustration of a closed mold such as illustrated in FIG. 5 and further showing the arrangement of the first iso/poly mixing gate, and second succeeding filler mixing gate according to the present invention;

FIG. 6A is an illustration of a poly/iso and filler combined three-dimensional material produced according to any of the reaction injection molding processes set forth in the present invention;

FIG. 7 is a further illustration of closed mold assembly, including iso/poly and filler mixing gates arranged in a further configuration and in order to supply a reaction injection material into the closed mold;

FIG. 8 is a still further example of an arrangement for multi-gate mixing and injection of iso/poly and filter materials; and

FIG. 9 is a yet further example of a gating and mixing application according to the present invention.

### DETAILED DESCRIPTION OF THE PREFERRED EMBODIMENTS

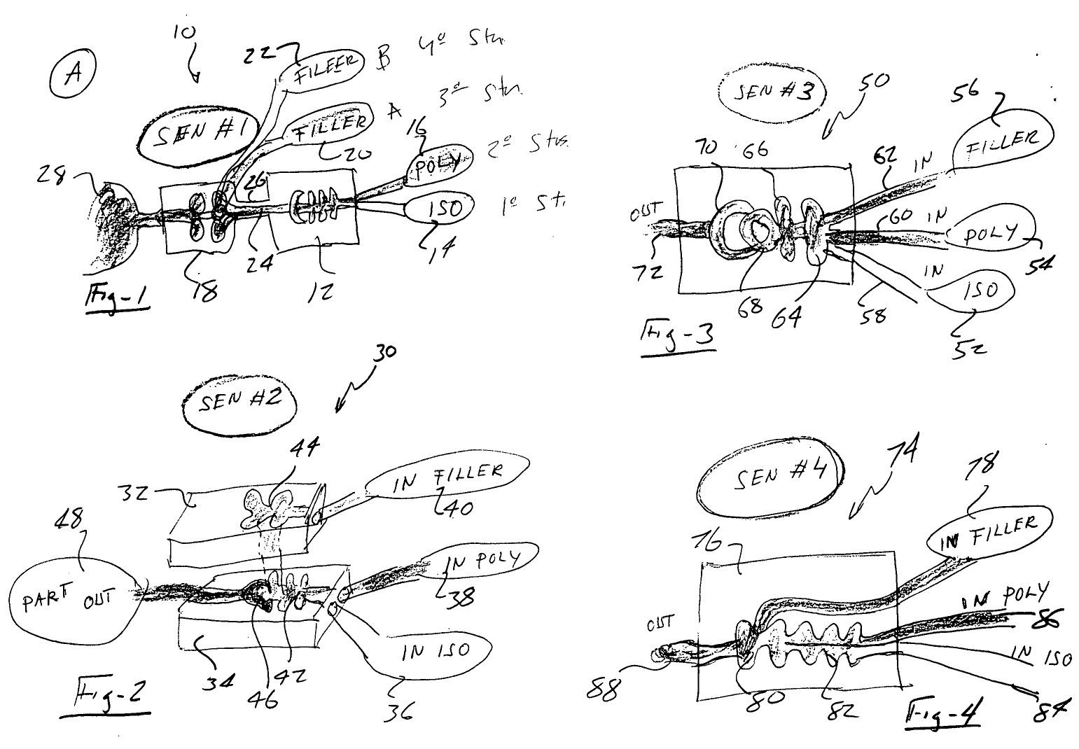

Referring now to FIG. 1, a first example, in cutaway, is shown at 10 of a closed reaction injection mold assembly including a first iso/poly mixing gate, combined with a succeeding gate for intermixing one or more aggregate filler materials and prior to depositing within a negative cavity associated with the mold.

The objective of the present invention (and as will be described in reference to each of the succeeding several embodiments) is the concurrent mixing, in a first gate 12, of an iso based material 14, such as provided in a heated state drawn from a fluidic reservoir, and which is combined with a poly based plasticized/polymer material 16, in turn drawn from a second reservoir.

The iso and poly based materials are preferably co-injected, in their fluidic state, into the associated and common gate 12 in a reaction injection molding process. The iso and poly based components are drawn, respectively, from suitable sub-class materials drawn from the general classification of polymers, this being further defined as including any of a class of natural or synthetic substances composed of macromolecules that are multiples of monomer based molecules.

Specifically, chains of unbranched or branched monomers (e.g., styrene based materials and the like) may be cross-linked or chained in two or three dimensions to form desired poly macromolecules. Additional types of synthetic organic polymers include many plastics, including polyethylene, nylons, polyurethanes, polyesters (e.g., vinyl or PVC), and synthetic rubbers. Further, silicone based polymers, those exhibiting an inorganic backbone of silicone and oxygen atoms and organic side groups, are among the most important mixed organic-inorganic compounds.

First mixing gate 12, as generally illustrated, includes such structure as a mixing impeller or like structure which facilitates intermixing of the liquid or fluidic state iso/poly materials in a suitable fashion and in order to create a substantially homogenous composition prior to communication of the composition into the associated mold. Other types of structure associated with the first gate 12 and for intermixing the fluidic components 14 and 16 may include any of a range of available elements for creating the desired and homogenized fluidic combination.

Referenced generally at 18, see again FIG. 1, is a second gate 18, and within which at least one filler material, and which is referenced by first and second filler materials 20 and 22, are co-introduced into the gate 18 in combining and communicating fashion with a homogenous liquid 24 combining the components of the previously intermixed iso 14 and poly 16 materials. The liquid 24 is conveyed from the first gate 12 through a passageway 26 communicating with the second gate 18.

The filler material(s) are selected from any range of fluid, powder or aggregate/particulate based organic and inorganic materials, and in particular such recyclable materials, the selection of which is predicated upon the desired end-product characteristics (e.g., strength, weight) of the product produced within the mold. Examples of filler materials 20 and 22 include gravel, sand, wood/cellulose based chips and shavings, as well as wide range of organic and/or inorganic materials.

In preferred variants, the present invention renders possible the mixing of different fillers of an aggregate nature and ranging from one-half a millimeter to five millimeters or greater in diameter. An associated mold assembly produces an end-product article 28, after a desired application of heat and pressure, the article incorporating the combination of the iso and poly components, combined with the filler material(s) intermixed therewith.

Referring now to FIG. 2, a further example is illustrated generally at 30 of a closed mold assembly exhibiting a further configuration for intermixing iso/poly materials with a specified aggregate filler. FIG. 2 provides a more detailed illustration of a closable/closed mold (see exploded halves 32 and 34) associated with the reaction injection molding process.

Associated input locations for the iso, poly, and filler materials are illustrated respectively at 36 and 38 (associated with mold half 34) and at 40 (associated with mold half 32). The iso 36 and poly 38 materials are combined at first gate 42, the resulting homogenized material stream further being admixed with the filler material 40 fed through communicating gate 44.

At 46, the combined mixture sets within an associated cavity in the mold and, after its desired period of heating and curing, is ejected as a finished part at 48. As with FIG. 1, and each of the succeeding illustrations, the arrangement and structure of the first mixing gate and second mixing is within the discretion of one of ordinary skill in the art and may include impeller driven mixers, co-extruders, and the like.

FIG. 3 illustrates a further example 50 of a closed mold according to a still further configuration of the present invention and for intermixing iso 52, poly 54, and filler 56 based materials and their associated feeder inputs 58, 60 and 62, respectively. The example 50 illustrated includes intermixing, in a single common gate 64, all three components. The iso 52 and poly 54 based materials again typically include first and second fluidic based materials, the filler material 56 further including such as an organic/inorganic granulate material exhibiting individual particulate diameters of ½ to 5 millimeters. The common mixing gate 64 admixes together a resultant composite material and which is fed in a particular manner through a conduit assembly, see bends and winds 66, 68 and 70, during which the desired product is formed and defined, such as through the additional application of heat and pressure, and prior to being discharged at 72.

FIG. 4 illustrates at 74 a yet further example of a closed mold arrangement 76 and by which a filler material 78 is intermixed (again in either a fluidic, powderized or granulate form) at a second gate 80, subsequent to an initial mixing/stream gate 82 associated with iso 84 and poly 86 based materials. The initial gate 82 may, as is illustrated by this embodiment, include a plurality of communicating and winding portions to homogenize the mixture of the iso 84 and poly 86 components.

The succeeding gate 80 corresponds to the admixture of the filler material 78, prior to heating and curing of discrete volumes of the combined material within the mold, and issuance of the desired end product 88. Additional variants may include other forms of molding or extrusion of the admixed compositions within the desires of one of skill in the art.

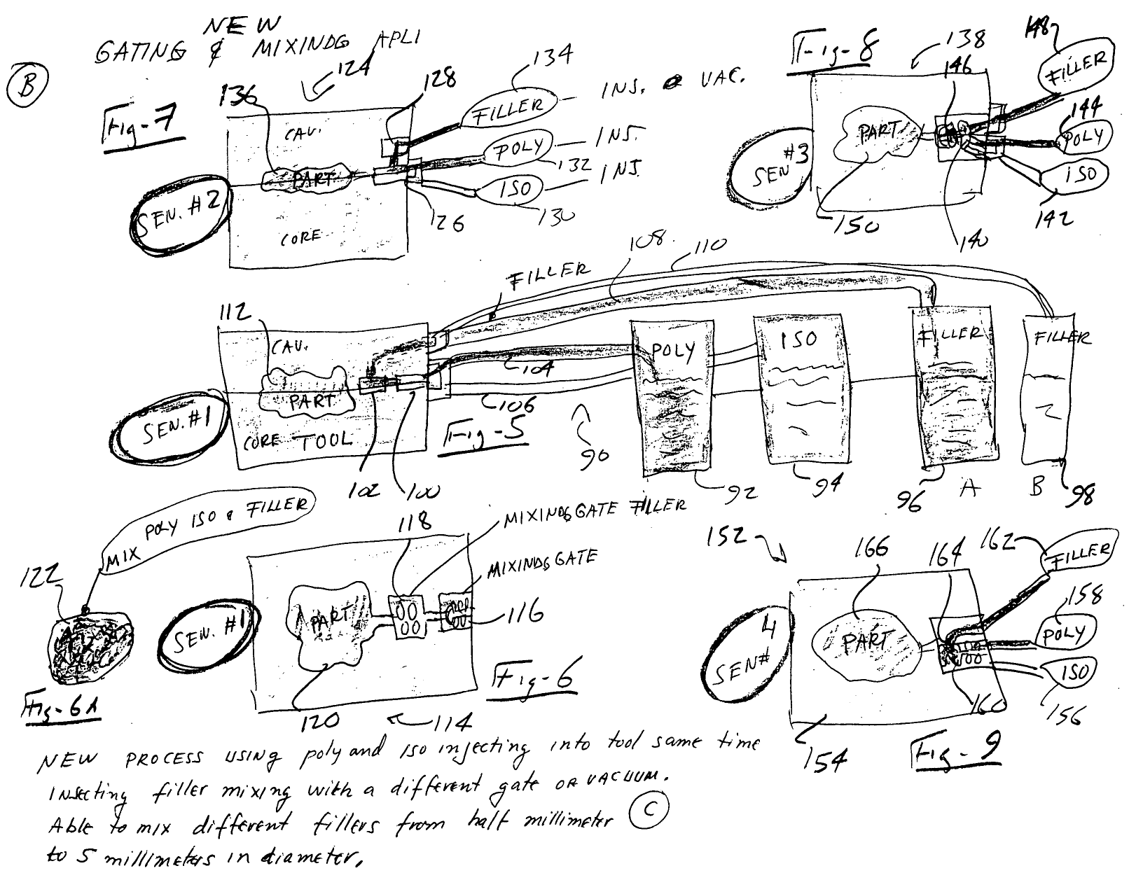

Referring now to FIG. 5, an illustration is generally shown at 90 of a mold assembly according to a yet further preferred embodiment. The mold assembly 90 includes volume holding reservoirs associated with the poly 92 and iso 94 based materials, in combination with first 96 and second 98 individual aggregate filler reservoirs, for supplying successive and communicating first 100 and second 102 mixing gates associated with a closed mold.

The poly material 92 is fed by line 104, the iso material 94 by line 106, each of which communicates with the first gate 100. The homogenously combined mixture is further admixed with the filler material 96, through communicating line 108 and, optionally, the filler material 98 through line 110, into the second gate 102 for admixture with the iso/poly combination. A cavity 112 defined within the mold receives a determined volume of the admixed material for treatment/curing and prior to issuing a finished part.

As is further shown in FIG. 6, a variant is illustrated at 114 of a closed mold, such as illustrated in FIG. 5, and further showing the arrangement of the first iso/poly mixing gate 116, and second succeeding filler mixing gate 118. A cavity 120 communicates with an outlet of the second mixing gate 118 in order to admit and form a volume of the combined material into a desired part.

FIG. 6A is an illustration, at 122, of a poly/iso and filler combined three-dimensional material produced according to any of the reaction injection molding processes set forth in the present invention. It is important to note that the shape, material construction and associated mechanical/chemical properties of the resultant three-dimensional part is modifiable within the scope of the present invention.

FIG. 7 is a further illustration, generally shown at 124, of closed mold assembly according to a further desired arrangement and again including iso/poly 126 and filler 128 mixing gates arranged in a further configuration and in order to supply a reaction injection material into the closed mold. Iso 130 and poly 132 materials are fed into the first gate 126, whereas selected filler material 134 is concurrently fed into second gate 128. As with the earlier described embodiments, cavity 136 receives and cures the admixed combination of material and prior to issuing a finished part.

FIG. 8 illustrates at 138 a still further example of another arrangement for multi-gate mixing and injection of iso/poly and filter materials. Initial mixing gate 140 combines the fluidic contents of iso-based material 142 and poly-based material 144. Communicating second gate 146 combines the fluidic material with an evenly distributed admixture of filler material 148, prior to the desired volume of material being fed into cavity 150 and molded into the desired part.

Referring finally to FIG. 9, a yet further example is shown generally at 152 of a gating and mixing application according to an embodiment of the present invention. A mold 154 includes a first mixing gate 160 (at an inlet side) for combining the desired iso 156 and poly 158 materials, concurrent with the filler material 162 being admixed through communicating second gate 164. The combined mixture is then inserted into the cavity 166 and in order to form the desired part.

Having described my invention, other and additional preferred embodiments will become apparent to those skilled in the art to which it pertains and without deviating from the scope of the appended claims.

I claim:

1. A multi-gate assembly for creating a composite article, comprising:
a mold including a closed interior cavity;
a first mixing gate in communication with said mold;
at least one iso-based polymer material and at least one poly-based polymer material concurrently fed into said first mixing gate; and
at least one filler material fed into a second gate in communication with said first gate, a composite associated with said iso/poly/filler materials being communicated into said cavity for formation into a three-dimensional article.

2. The gate assembly as described in claim 1, each of said iso and poly based materials having a fluidic composition.

3. The gate assembly as described in claim 1, said filler material further comprising at least one of a fluidic, powderized or granulate/aggregate consistency.

4. The gate assembly as described in claim 1, said filler material further comprising a particulate material, each exhibiting an individual diameter in a range of between ½ to 5 millimeters.

5. The gate assembly as described in claim 1, said filler material including at least an organic or inorganic based material.

6. The gate assembly as described in claim 1, further comprising a first filler material reservoir and a second filler material reservoir, said first and second filler materials being fed into said second gate.

7. The gate assembly as described in claim 1, said second gate being located in fluidly communicating fashion with an outlet location associated with said first gate.

8. A multi-gate assembly for creating a composite article, comprising:
a mold including a closed interior cavity;
at least one mixing gate in communication with said mold;
at least one iso-based polymer material and at least one poly-based polymer material concurrently fed into said mixing gate; and
at least one filler material concurrently fed into said gate, a composite associated with said iso/poly/filler materials being communicated into said cavity for formation into a three-dimensional article.
